(19) United States
(12) Patent Application Publication
(10) Pub. No.: US 2016/0328807 A1
(43) Pub. Date: Nov. 10, 2016

(54) SOCIAL INTERACTION PLATFORM THROUGH PSYCHOMETRIC ASSESSMENTS MANAGEMENT

(71) Applicant: XGENYZ Sociedad Anonima, Casa Diez (CR)

(72) Inventors: Eduardo Alfaro Sanchez, Casa Diez (CR); Daniel Antonio Blanco Rojas, Heredia (CR)

(73) Assignee: XGENYZ SOCIEDAD ANONIMA, Casa Diez (CR)

(21) Appl. No.: 14/720,184

(22) Filed: May 22, 2015

(30) Foreign Application Priority Data
May 8, 2015 (CR) 2015-0239

(51) Int. Cl. G06Q 50/00; H04L 12/58; G06Q 10/10; H04L 29/08

(52) U.S. Cl. CPC G06Q 50/01; H04L 67/306; H04L 51/32; G06Q 10/10

(57) ABSTRACT

A platform for the interaction of employers and workers, individuals, groups of individuals and organizations through internal social networks for each company (organization), which identifies the personality of each of the users that comprise the social network through personality and self-esteem, communication and leadership assessments. As a result, employers, organizations, individuals and groups of individuals have the opportunity to help, through practical advice provided by the platform, the users to strengthen their own virtues and to develop skills in areas of improvement, generate pleasant, satisfying and high performance work environments and groups.

### CROSS-REFERENCE TO RELATED APPLICATIONS

This application claims the benefit under 35 U.S.C. §119(a) of Costa Rican patent application No. 2015-0239, filed on May 8, 2015, which is currently pending, the contents of which are hereby incorporated by reference in their entirety.

### FIELD OF THE INVENTION

This invention relates to the technological tools used for human resource management and psychometric evaluations obtained through interactions on social network.

### BACKGROUND OF THE INVENTION

This invention relates generally to social networks, and in particular to human resources management and training groups from psychometric studies that could be obtained from the individuals involved. It generates a new model of virtual interaction that could improve human and work relations, understanding the strengths and skills of individuals and acknowledging weaknesses in order to work on them.

A state of the art invention does not exist to provide a social network as a tool for human resource management subject to this management model.

Social network systems to date allow users to create accounts that are linked to their identity. The social networking system allows users to post items, such as photos and videos, and take action, as commenting and messaging (collectively the objects and actions are called “content”). Occasionally users of social network system can have access to other users' content.

Social network systems allow users to generate reports that identify inappropriate content, as they are present but do not identify the personality of its members.

In recent years, the volume of reports from users of social network systems has provoked that human resources management is used as a mechanism to facilitate monitoring and understanding of individuals.

For these reasons there has been an urgent need for a system that can successfully analyze reports of human resources and adequate cause interactions.

With the development of economy and society, the role of interpersonal interaction is increasingly important for personal and professional development. The management and expansion of social network resources of an individual in real time is considered. It is clearly effective resume interpersonal management systems (such as contacts, type of software).

Moreover, evaluation systems regarding the capability or psychological state of individuals have allowed building profiles that facilitates human resources management to efficiently manage staff focusing their skills, directing their strengths and improving their weaknesses.

A virtual system allowing adequate social network integration with evaluation mechanisms which in turn generates an efficient management and communication labor tool does not exist.

Therefore, this tool is meant to generate a comprehensive solution that is projected as the new social network for human resource management.

### DESCRIPTION OF THE INVENTION

This invention is a platform for interaction between employers and employees, individuals, groups of individuals and organizations through internal social networks for each company (organization), which identifies the personality of each of the users that compose the social network through personality and self-esteem, communication and leadership evaluations. The platform provides employers, organizations, individuals and groups of individuals the opportunity to learn, through practical advice provided by the platform, to treat their users in order to strengthen the virtues of each member and develop skills in areas of improvement to promote pleasant and high performance work environments and work teams.

The technology platform also allows users to create customized records of users and administrators of a social network, and it is possible to create independent groups and subgroups, identification of parameters derived from psychometric personality assessments of each individual and of a group, performing psychometric self-assessments, storage of data as a result of the evaluations, and the internal organization of teams through interaction groups and subgroups.

The platform comprises a user registration system, a main network administrator, secondary network administrators, a section of management for administrators, a section of user management, a notifications system, an external networks adhesion system, an evaluations system, a control system and personality reports storage, a system of coaching tips regarding assessment results, a daily log, access to create private and public groups and subgroups, and an interaction system for users.

The platform allows the user registration and the creation of both user profiles as well as social networks. The user who creates the network becomes the principal administrator thereof.

A platform has an evaluation system consisting of a set of tools that can be used independently or complementarily. These tools include psychometric assessment tools for analysis of network members; psychometric assessment tools; communication tools; and leadership tools.

The communication tool platform can measure whether the leader is a good communicator, if he is average or if communication is poor in order to qualify the individual and provide tools and tips for your personal improvement.

The leadership tool determines the leadership style of the person in terms of effectiveness, from the mix of styles determined by the tool.

The tool allows to create secondary administrators manage and control information.

The social network that promotes the tool has a management section for administrators of the social network that allows full management, allowing the administrator to configure the language in Spanish or English; add a picture as a differentiating element of social network and define the privacy settings of the social network in open, private or by invitation. Likewise, the administrator through this section has access to all the information that is generated.

The social network has a management section for users of the social network that allow changes in the personal profile information: name, surname(s), email, biography, date of birth, sex and photography, as well as change the password of your account and define your preferences for display or not your date of birth, sex and generation.

The social network also has a membership system to external networks, which works in different ways depending on the degree of privacy of each network, as it can be open, private or operated only by invitation of the network administrators social.

It has a notification system that allows administrators to learn about the application for a user to be part of the social network. These notifications allow users to learn about the requests sent by the manager of a social network to join the network, through email addresses, allowing the user to be aware of requests for conducting psychometric evaluations.

The social network has an assessment section, where users can be subject of psychometric personality assessments to personal and social skills, either by request of network administrator, another user on the network social or by the user himself. These assessments can be applied at the request of a party or on a voluntary basis and generate results that are accessed by both by the subject of analysis and by the administrator, allowing profiling and assessments to advise or position the subject.

It allows users to consolidate a 360 assessment where a user requests to other users psychometric personality assessments to compare the user's original report with other users' report.

The social network allows control of applications for evaluation and those that are pending, since it has a section that reports these requirements, the origin and its status.

The data obtained as a result of the psychometric assessments made to users are stored and tracked within the Personality Report System.

The main administrator secondary administrators can share with each other the results of users psychometric evaluations.

The system of coaching tips regarding the different personality types that are determined in the psychometric assessments to guide one-on-one meetings based on the user profile personality to guide the direction wanted in regards to personal or business development.

There is also a log that offers the possibility to the user and the network administrator to freely enter notes.

The administrator can organize users into groups and subgroups, according to the results of psychometric assessments.

The social network allows users interact dynamically and contains an interaction system via a live chat where you can also share files of any format.

Additionally, interaction occurs through the wall publications, chat or social network community and in turn allows the creation of portable collective documents.

The platform, hence, allows user registration and the creation of both user profiles as well as social networks and conducting psychometric personality assessments, communication and leadership skills that can be used to organize groups and subgroups within each social network.

The primary and secondary administrator can have full management of the network, allowing the administrator to configure the language in Spanish or English; add a picture as a differentiating element of social network and define the privacy settings of the social network open, private or by invitation. In any case, the administrator has access through this section.

The social network has a management section for users of the social network that allow changes in the personal profile information: name, surname (s), email, biography, date of birth, sex and photography, as well as change the password of your account and define your preferences for display or not your date of birth, sex and generation.

It is even possible adding users to external networks, depending on the privacy of the social network, as it can be open, private or by invitation only.

The social network has a notification system that allows administrators to make user requests to the social network; It allows users to be aware of the requests sent by the manager of a social network to join the network, through email addresses, allowing the user to be aware of requests for psychometric evaluations. Conducting psychometric personality assessments on a personal level and social skills to users is allowed.

Administrators can control the psychometric, communication and leadership assessments and the data obtained as a result of the evaluations to be stored and tracked within the social network.

It is possible to share the results of psychometric evaluations of users and give advice or virtual mentoring in regards to different personality types that are determined on assessments to guide one-on-one meetings based on the user's personality profile to guide the direction that you want at personal development or business level.

Interaction between administrators and users can occur through organized groups and subgroups, through personality factors within each social network, like interaction through the social network chat in the platform.

This system can become in an application for smart mobile devices. This is an application for smart mobile devices with a technology platform for creating social networks, which can generate personalized files of users of a social network that allows the creation of independent groups and subgroups, parameters identification derived from psychometric personality assessments of each individual and group performance of psychometric personality self-assessments, result data storage, internal organization of teams through interaction groups and subgroups.

What it claimed is:

1. A technology platform to generate customized records of users and administrators of a social network that allows the creation of independent groups and subgroups, identification of parameters derived from personality psychometric assessments of each individual and group self-assessments implementing psychometric personality storage data obtained as a result of the evaluations, internal organization of teams through interaction groups and subgroups, comprising:
a user registration system;
a main network administrator;
secondary network administrators;
a management section for administrators;
a management section for users;
a notification system;
a linkage to external networks system;
a section of evaluations;
a control system and storage of personality reports;
a system of coaching tips regarding evaluation results;
a log;
access to create private and public groups and subgroups; and
a system of interaction between users.

2. A platform of claim 1 where the platform allows user registration and the creation of both user profiles and social networks.

3. A platform of claim 1 where the user creating the social network becomes the main administrator.

4. A platform of claim 1 wherein the evaluation system comprises a set of tools that can be used independently or complementarily, comprising:
a. psychometric assessment tools;
b. communication tools; and
c. leadership tools

5. A platform of claim 4, where the communication tool measures if the leader is a good communicator, if he is rated within the average or if communication is poor in order to rate the individual and provide tools and advice for improvement.

6. A platform of claim 4, wherein the leadership tool determines the leadership style of the person in terms of effectiveness, from the mix of styles determined by the tool.

7. A platform of claim 1, where secondary administrators can be created.

8. A platform of claim 1, wherein the network has a management section for administrators of the social network that allows the full management of the network, allowing the administrator to configure the language in Spanish or English, add a picture as a differentiating element of social network, and define the privacy settings of the social network as open, private or by invitation, and wherein the administrator has access to this section.

9. A platform of claim 1, wherein the network has a management section for users of the social network that allow changes in the personal profile information, comprising name, surname(s), email, biography, date of birth, sex, photography, and combinations thereof, and where the user is able to change its account password and define one or more preferences for display of date of birth, sex and/or generation.

10. A platform of claim 1 wherein the social network has a membership system to external networks, which works in different ways depending on the degree of privacy of each network, as it can be open, private or operated only by invitation through the social network administrators.

11. A platform of claim 1 wherein the social network has a notification system that enables administrators to be aware of a user's request to be part of the social network, and wherein users may learn of the requests sent by the administrator of a social network to join the network, through email addresses, whereby the user is aware of requests for conducting psychometric evaluations.

12. A platform of claim 1, wherein the network has an assessments section, where users can be the subject of psychometric personality assessments on a personal and social skills level, either through the social network administrator, another user of the social network or the user's request.

13. A platform of claim 1 wherein the social network allows users to consolidate an 360° assessment where a user requests to other users performing personality psychometric assessments to compare the user's original report with the report of other users.

14. A platform of claim 1 wherein the social network allows control of evaluation requests and those that are pending.

15. A platform of claim 1, wherein the data obtained as a result of the psychometric assessments of users are stored and tracked within a personality report system.

16. A platform of claim 1 where the social network allows the main administrator and secondary administrators to share among themselves the results of users' psychometric evaluations.

17. A platform of claim 1, where the network has a system of coaching tips regarding the different personality types that are determined in the psychometric assessments to guide one-on-one meetings based on the user personality profile to guide the direction wanted on a personal development or business level.

18. A platform of claim 1 where the social network has a log that allows the user and the network administrator to freely enter notes.

19. A platform of claim 1 where the social network allows users to organize into groups and subgroups, according to the results of psychometric assessments.

20. A platform of claim 1 wherein the social network allows users to interact dynamically.

21. A platform of claim 1 where the social network comprises a system of interaction via a live chat.

22. A platform of claim 1, where files can be shared through the social network chat.

23. A platform of claim 1, which allows interaction through the wall, chat or social network community and in turn allows the creation of portable collective.

24. An integrated method for user registration and the creation of both user profiles and social networking and conducting psychometric personality assessments, communication and leadership skills that can be used to organize groups and subgroups within each social network.

25. A method of claim 24, which allows the primary and secondary administrators to have full management of the network, allowing the administrator to configure the language in Spanish or English, add a picture as a differentiating element of social network and define the privacy settings of the social network as open, private or by invitation, and wherein the administrator has access to this section.

26. A method of claim 24, wherein the social network has a management section for users of the social network that allow changes in the personal profile information, comprising name, surname(s), email, biography, date of birth, sex, photography, and combination thereof, and where the user is able to change its account password and define one or more preferences for display of date of birth, sex and/or generation.

27. A method of claim 24, which allows users to link to external networks, depending on the privacy of the social network, as it can be open, private or by invitation only.

28. A method of claim 24, where the social network has a notification system that enables administrators to be aware of a user's request to be part of the social network, and wherein users may learn of the requests sent by the social network administrator to join the network, through email addresses, whereby the user is aware of requests for conducting psychometric evaluations.

29. A method of claim 24, which allows users to request personality psychometric assessments on a personal and social skills level.

30. A method of claim 24, which allows the consolidation of a 360 assessment where a user requests to other users performing psychometric personality assessments to compare the user's original report with the reports of other users.

31. A method of claim 24, which allows for control of the psychometric assessments, communication and leadership to perform, and the data obtained as a result of the evaluations are stored and tracked within the social network.

32. A method of claim 24, which allows the main administrator and secondary administrators to share the results of users' psychometric evaluations.

33. A method of claim 24, which allows the administrator to have a coaching tips method regarding the different personality types that are determined on assessments to guide one-on-one meetings based on the user's personality profile in order to lead the direction wanted to level personal development or business.

34. A method of claim 24, which allows both the administrator and the user to have a log to enter notes.

35. A method of claim 24, which allows the administrator to organize users into groups and subgroups working through the results of psychometric personality assessments.

36. A method of claim 24, which allows user interaction via a live chat.

37. A method of claim 24, where files can be shared via the social network chat.

38. A method of claim 24, which allows interaction through chat and the wall of the network and in turn allows the creation of portable documents comprising this interaction.

39. A mechanism of interaction between administrators and users through organized groups and subgroups, through personality factors within each social network, as well as interaction through the social network chat using a platform comprising:
a user registration system;
a main network administrator;
secondary network administrators;
a management section for administrators;
a management section for users;
a notification system;
a linkage to external networks system;
a section of evaluations;
a control system and storage of personality reports;
a system of coaching tips regarding evaluation results;
a log;
access to create private and public groups and subgroups; and
a system of interaction between users;
and the process of claim 24, comprising:
a user registration system;
a main network administrator;
secondary network administrators;
a management section for administrators;
a management section for users;
a notification system;
a linkage system to external networks;
a section of personal evaluations;
a control system and personality reports storage;
a system of coaching tips regarding evaluation results;
a log;
access to create private and public groups and subgroups; and
an interaction system.

40. An application for smart mobile devices using the method of claim 28, and a platform, comprising:
a user registration system;
a main network administrator;
secondary network administrators;
a management section for administrators;
a management section for users;
a notification system;
a linkage to external networks system;
a section of evaluations;
a control system and storage of personality reports;
a system of coaching tips regarding evaluation results;
a log;
access to create private and public groups and subgroups; and
a system of interaction between users.

41. An application for smart mobile devices with a technology platform for social networking, which creates personalized files of a social network users and also allows setting up independent groups and subgroups, identification of parameters derived from personality psychometric assessments of each individual and group, the execution of psychometric personality self-assessments, data storage as a result of the evaluations, internal organization of teams through interaction groups and subgroups, and comprising:
a user registration system;
a main network administrator;
secondary network administrators;
a management section for administrators;
a management section for users;
a notification system;
a linkage system to external networks;
a section of personal evaluations;
a control system and personality reports storage;
a system of coaching tips regarding evaluation results;
a log;
access to create private and public groups and subgroups; and
an interaction system.
